(19) United States
(12) Patent Application Publication
(10) Pub. No.: US 2006/0268549 A1
(43) Pub. Date: Nov. 30, 2006

(54) Omnidirectional light

(76) Inventor: Shawn Oehlke, Crosby, ND (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/430,548

(22) Filed: May 9, 2006

Related U.S. Application Data
(60) Provisional application No. 60/679,139, filed on May 9, 2005.

(51) Int. Cl. F21V 23/04

(52) U.S. Cl. 362/276

(57) ABSTRACT

A light engine for generating what appears to be an omnidirectional light source by generating a concentrated beam of light in a specific direction and sweeping that beam at a high rate of speed in a complete circle. The light engine includes sub-assemblies that are coupled to each other by a snap-on type fit so that cost is minimized and assembly is simplified.

### PRIORITY CLAIMED

This application claims priority under 35 U.S.C. § 119(e) to U.S. Ser. No. 60/679,139, filed May 9, 2005, which is hereby incorporated in its entirety by reference thereto.

### TECHNICAL FIELD

The embodiments of the invention relate, generally, to illumination devices, and, more particularly, to an omnidirectional light having a stationary light source.

### BACKGROUND

Conventional light bulbs are omnidirectional, but their illumination is not intense beyond a short distance. In order to provide a light that would cast its illumination over greater distances, flashlights and spotlights have been developed. These devices focus the light beam so that it travels over greater distances, but the omnidirectionality of the light is lost.

Accordingly, a number of devices have developed light fixtures having focused beams that spin about an axis at a high rate of speed. These fast spinning lights were the first to provide omnidirectional light beyond the capabilities of a fixed position light source, but the mechanical forces acting upon the bulbs shortened the lifecycle of such spinning bulbs and made them unacceptable.

U.S. Pat. No. 4,054,791 describes a portable lantern that has a high speed rotary beam. A mirror was mounted at a forty five degree angle relative to the vertical and spun at high speeds. The result was a fast-spinning spotlight beam that provided an intense omnidirectional light.

It has been determined, however, that a rapidly rotating mirror positioned at forty five degree angle is subjected to rotational problems because of inherent instability of a flat, planar article mounted at a forty five degree angle. Thus, at high speeds of rotation, vibration appears and greater rotational speeds cannot be obtained.

U.S. Pat. No. 5,126,923 describes an omnidirectional light that uses a single light source that directs a light beam onto a pair of mirrors rotating at hundreds of revolutions per second. The mirrors are mounted in an “X” configuration to provide vibration free operation. The light beam is split in half and directed in opposite directions by the mirrors.

U.S. Pat. No. 5,057,827 discloses a device for producing an optical illusion. A rotary member is rotated and light images are produced in a radial direction from the rotary member. FIG. 7 shows an embodiment in which a single light image element 202 is used. The element 202 is located along a central axis of and within a tube bored out at one end 204 that extends from a motor 206. The bored out tube allows the placement of a LED or laser diode inside the one end of the bored out tube with no pass-through for beam conduction from a fixed light source within the base. This bored out tube is then mounted to the actual shaft of the motor and spun. A reflecting surface 212 is hingedly mounted on a hinge 210 at an axial end of the hollow shaft 204. The reflecting surface can be used to redirect the light emitted by the element 202 onto a luminescent surface 214. Wherever the light strikes, an observer will observe a lighted pixel or dot of light on the surface 214. The pivoting of the reflecting surface 212 is controlled by a controller 216 connected to a rod 218 and a carrier 220. Because of the mounting of the reflective surface 212 on the axial end of the rotating hollow shaft, the device may be subject to balancing concerns. Also, because the light source is mounted in the hollow shaft above the motor, supplying energy to the source is more complicated.

It is desirable to provide a lighting system that is vibration free, utilizes low power and provides high output. In addition, it is desirable to provide a lighting system that is compact, easily manufactured and relatively inexpensive. Also, it is desirable to provide a lighting system that presents lower environmental hazards and increased safety compared to known light sources.

### SUMMARY

In one embodiment, an illumination device has a base, a motor mounted on the base and a rotation assembly mounted on the motor. The base receives scattered light and focuses the scattered light into a beam of light. The motor has a rotatable hollow shaft located to receive a beam of light. The rotation assembly includes a rotatable optics shaft coupled to the hollow shaft of the motor so that the optics shaft rotates with the hollow shaft of the motor. A reflector is located in the optics shaft wherein the beam of light received through the hollow shaft of the motor impinges the reflector and is directed through a side wall of the optics shaft.

The base may have a light source mounted therein. The light source may be an array of LEDs. The base may include a collimation optical element located at the center of the array of LEDs. The collimation optical element may be a cone reflector. The reflector located in the optics shaft is tilted at an angle ranging from about 35 degree AOI to an angle of about 55 degree AOI. The reflector may be tilted at an angle of about 45 degree AOI.

According to one aspect of the invention, there is provided an illumination device having a motor, a rotation assembly and a reflector. The motor has a rotatable hollow shaft located to receive a beam of light. The rotation assembly is mounted on the motor and includes a rotatable optics shaft coupled to the hollow shaft of the motor so that the optics shaft rotates with the hollow shaft of the motor. The reflector is located in the optics shaft where the beam of light received by the hollow shaft of the motor travels through the rotatable optics shaft and impinges the reflector and is directed through a side wall of the optics shaft.

According to another aspect of the invention, there is provided an illumination device having a motor, a rotation assembly and primary optics. The motor has a rotatable hollow shaft located to receive a beam of light. The rotation assembly is mounted on the motor and includes a rotatable optics shaft coupled to the hollow shaft of the motor so that the optics shaft rotates with the hollow shaft of the motor. The primary optics are located on the rotatable optics shaft where the beam of light received by the hollow shaft of the motor travels through the rotatable optics shaft and impinges the primary optics and is directed through a side wall of the rotation optics shaft.

According to still another aspect of the invention, there is provided a method of providing omnidirectional lighting by generating a concentrated beam of light using a plurality of LED and sweeping the concentrated beam of light 360° at a rate ranging from about 3,000 rpm to about 10,000 rpm.

### DESCRIPTION OF THE DRAWINGS

For a fuller understanding of the embodiments of the invention, reference should be made to the following detailed exception, taken in conjunction with the accompanying drawings.

FIG. 1 is a front perspective view of an embodiment of an omnidirectional light system with its dome removed.

FIG. 2 is a front perspective view of the omnidirectional light system shown in FIG. 1 with its dome in place.

FIG. 3 is a top elevation schematic of a portion of the base subassembly.

FIG. 4 is a cross sectional schematic of an embodiment of an omnidirectional light.

FIG. 5 is a perspective view of the rotation subassembly extending from the motor into the dome.

FIG. 6 is a perspective view of the primary optics that fits within the optic shaft shown in FIG. 5.

FIG. 7 is an alternate embodiment of an optics shaft with the primary optics incorporated therein.

FIG. 8 is a schematic drawing of another embodiment of an omnidirectional light system

FIG. 9 is a schematic drawing of the lighting device shown in FIG. 8 fully assembled.

FIGS. 10-13 are schematic diagrams of a lighting system according to another embodiment of the invention.

### DETAILED DESCRIPTION

Unlike traditional flood illumination, where photons are disbursed over a large area in a continuous fashion, the embodiments of the lighting device of the present invention directs a concentrated beam, i.e., spot light, in a specific direction and sweeps that beam at a high rate of speed in a complete circle. Exploiting the fact that the human eye samples approximately 30 frames per second, the beam of light will make at least one full 360 degree sweep in the time it takes the eye to sample once, thus giving the impression that the illumination is continuous.

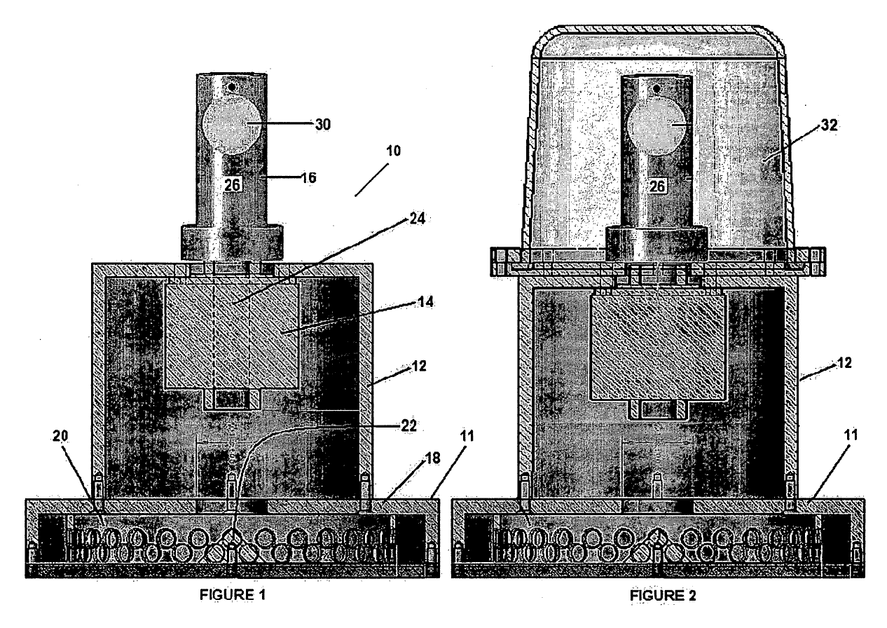

FIG. 1 is a front perspective view of an embodiment of an omnidirectional light system 10 with its dome 32 (see FIG. 2) removed. The light system 10 is composed of three main parts: a base subassembly 11, a motor 14 located in a housing 12, and a rotation subassembly 16. The base subassembly 11 includes several parts including a housing 18, an LED array 20, and beam direction optics 22. The motor 14 includes a hollow shaft 24 that extends down towards the base subassembly housing 18 as shown. The rotation subassembly 16 includes an optics shaft 26 coupled to the hollow shaft 24 of the motor 14 and a primary optic (not shown) located in the optics shaft 26. A window 30 formed in the optics shaft 26 directs the light to the external environment as will be described in detail hereinafter.

FIG. 2 is a front perspective view of the omnidirectional light system 10 shown in FIG. 1 with its dome 32 in place. The dome 32 is preferably clear and is made of a plastic or glass. Alternately, the dome 32 may be colored using conventional techniques. The dome 32 protects the optics shaft 26 and optics from the environment in which the light system 10 is placed. In addition, the dome may be substantially clear and include an opaque shroud covering part of the dome for blocking transmission of radiation in a preselected direction. Also, the dome may include a reflector for enhancing the illumination of a preselected area.

A description of the operation of the light system 10 will now be described. The LED array 20 is powered by a 12 Volt DC source. The light emitted from the LED array 20 is collected, focused and collimated by beam control optics. In a preferred embodiment, the beam control optics includes the beam direction optics 22 located in the base subassembly 11 in the form of a cone prism and a focusing and collimation lens (not shown) located in the hollow shaft 24 of the motor. The collimated light is directed up the hollow shaft 24 of the motor 14 and the rotation subassembly 16 coupled to the motor 14 where it impinges on the primary reflector and is directed through the window 30 formed in the optics shaft 26 and then out through the dome 32. The motor 14 rotates at a speed ranging from about 3,000 rpm to about 10,000 rpm. The light that is emitted into the environment in which the light system 10 is placed appears continuous. Because LEDs are used, the lighting device is safer than conventional lighting sources such as mercury lamps, for example.

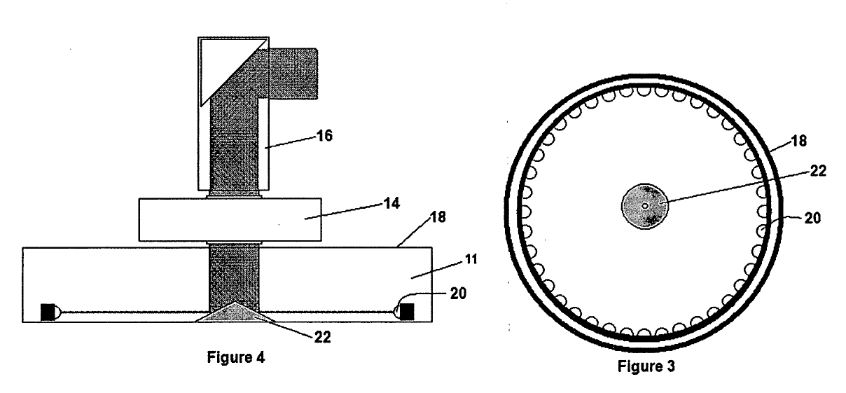

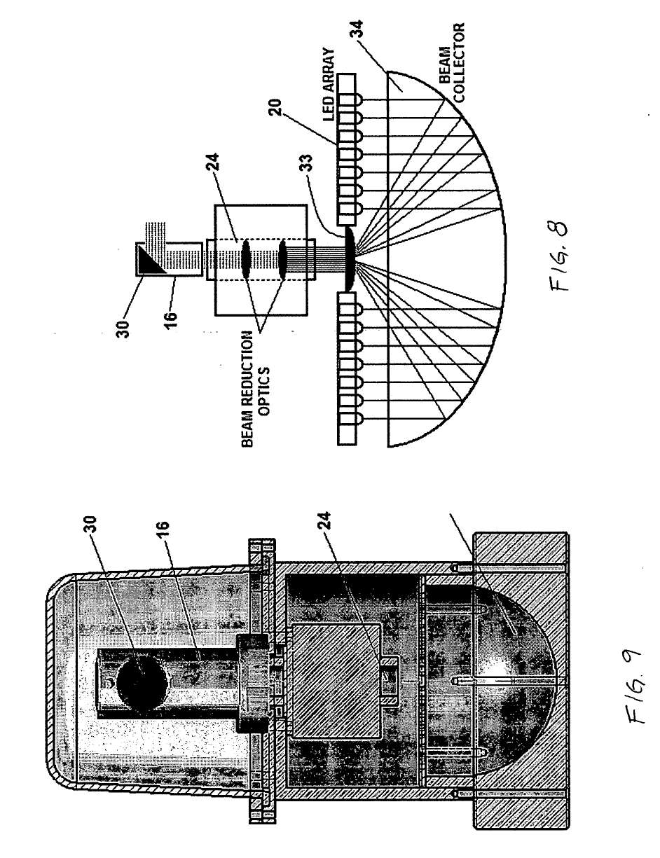

FIG. 3 is a top elevation schematic of a portion of the base subassembly 11 located in housing 18. As previously stated, the base subassembly 11 includes housing 18, an LED array 20 and part of the beam control optics 22. Preferably the housing 18 is made of a plastic although it need not be. The interior surface of the housing 18 in which part of the beam control optics are located is coated with a reflective material, such as an aluminum flashing, as is known from constructing automobile headlight reflectors. The housing 18 preferably has a cylindrical shape although it may have other shapes, particularly depending on the application to which it will be put. In one embodiment, the LED array 20 is in the form of a ring that encircles the interior perimeter wall of the housing 18 and is located at the base of the housing 18. The LED array 20 is formed by a ring having individual mounting structures for each LED. The mounting structures may be holes or slots, for example or any other structure designed to hold LEDs. Each LED is provided with its own wiring. The LED array with the LEDs is mounted on the floor of the base subassembly 11. The LED array 20 can be mounted on other parts of the base subassembly 11 as will be described with reference to FIG. 8 and need not be in the form of a ring. The collection optics is located on the base of the housing 18, preferably at its center. The focusing and collimating optics (not shown) are located inside the hollow shaft 24 of the motor.

FIG. 4 is a cross sectional schematic of an embodiment of an omnidirectional light. The light path is shown as a shaded line. The hollow shaft 24 of the motor 14 extends into the base subassembly 11 directly over the collection optics 22. Preferably the motor is a brushless motor. Preferably, the motor 14 snaps onto the base subassembly 11. The rotation subassembly 16 fits on top of the motor 14 and preferably snaps into place. Because of this snap-on type fit between the three components, cost is minimized and assembly is simplified because the three components can be delivered to an assembly line as complete assemblies. In a preferred embodiment, the rotation subassembly 16 is made of plastic although it need not be. The rotation subassembly 16 includes the optics shaft which is optically transmissive that attaches to the hollow shaft 24 of the motor so that it rotates with the hollow shaft. In addition, the primary optics 28 is fitted inside the optics shaft as will be described with reference to FIG. 5. The optics shaft may, in one embodiment, be formed by a hollow tube preferably made of plastic for inertial concerns, but need not be plastic. The optics shaft 26 of the rotation subassembly 16 rotates with the shaft of the motor 14 while the dome 32, which is not shown in the cross section of FIG. 4, remains stationary.

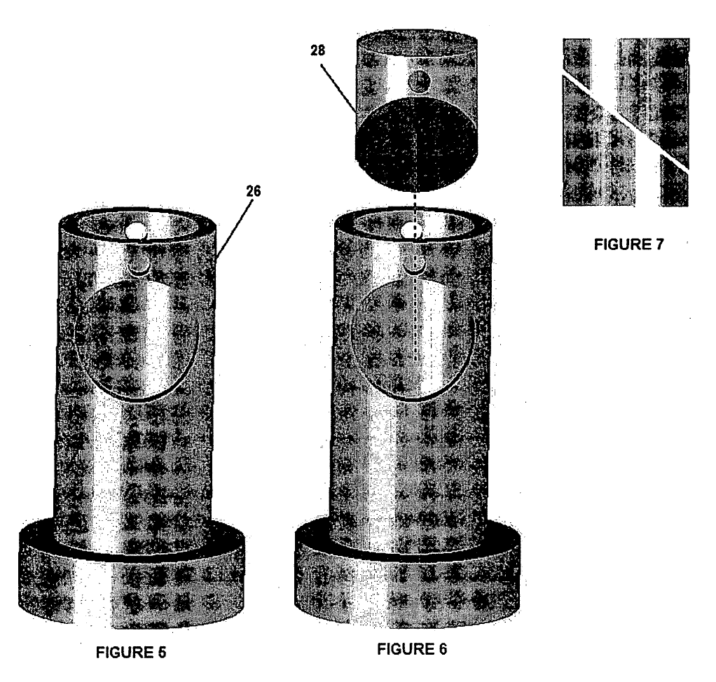

FIG. 5 is a perspective view of the optics shaft 26 extending from the motor 14 into the dome 32. In this embodiment, the optics shaft 26 is a hollow, cylindrical shaft that has an open top end. A window 30 is formed in a side of the optics shaft 26 through which the beam of light will be directed as will be described in detail hereinafter. The interior of the optics shaft 26 is provided with a rim (not shown) located just under the window 30 that helps properly position and support the primary optics 28 which is inserted into the optics shaft as will be described with reference to FIG. 6

FIG. 6 is a perspective view of the primary optics 28 that fits within the optics shaft 26 shown in FIG. 5. As previously described, the optics shaft 26 shown in FIG. 5 is hollow and has an open top. The primary optics 28 is in the shape of a cylinder with its bottom portion cut at an angle ranging from about 35 degree to about 55 degree Angle of Incidence (AOI), and, more preferably, at an angle of 45 degree AOI. The bottom angled surface of the primary optics 28 is coated with a reflective material such as aluminum or silver, to form a reflector. The reflector could also be coated with a material with reflective qualities at specific wavelengths, i.e., gold for infrared wavelengths. In this embodiment, the reflector is shown as a planar member although it need not be. The reflector may be curved so that it has a concave or convex reflective surface, for example. The primary optics is inserted into the top of the hollow shaft and is positioned and supported by the rim (not shown) formed on the interior of the hollow shaft. The primary optics 28 is secured inside the hollow shaft, utilizing epoxies and/or mechanical fasteners such as screws or pins. The rotation subassembly 16 is thus provided with one reflective surface.

FIG. 7 is an alternate embodiment of the primary optics and addresses balancing concerns. As previously mentioned, the optics shaft is optically transmissive. In this embodiment, the primary optics 28 is formed using a clear acrylic rod (or any other optically transmissive materials). The rod is cut in half at an angle ranging from about 35 degrees to about 55 degrees and, more preferably, at an angle of about 45 degrees with respect to the end of the rod. A reflective coating is applied to the angled surface of the top half of the cylindrical rod and then the two pieces are bonded back together preferably using an epoxy. This embodiment provides a balanced system 10 since a solid cylinder is used. As was discussed with reference to U.S. Pat. No. 4,054,791, a symmetrical two mirror system was provided because it was thought that a balanced system could not be obtained using solely one reflective surface.

FIG. 8 is a schematic drawing of another embodiment of an omnidirectional light system 10. The housing for the base subassembly and motor are not shown in order to simplify the description of this embodiment. In this embodiment, the LED array 20 is an array mounted in the top of the housing of the base subassembly with the LEDs directed towards the floor of the subassembly. Located on the floor of the base subassembly is a reflective parabolic dish 34 pointing upwards towards the LEDs. The parabolic dish functions as a beam collector. The beam collector 34 collects the beams and directs them onto a beam collimator 33 which collimates the beams and directs them into the hollow shaft 24 of the motor. Located in the hollow shaft 24 of the motor 14 are beam reduction optics, preferably in the form of two spaced apart lenses. The beam is then directed to the primary optics 28.

FIG. 9 is a schematic drawing of the lighting device shown in FIG. 8 fully assembled.

In a preferred embodiment, the LED array used in the embodiments of the invention may be either of the configuration shown in FIG. 1 or FIG. 8. More preferably, in order to get a true white light from the lighting system 10 according to the embodiments of the invention, when needed, red, green and blue LEDs are used in the following quantities: 50% blue (470 nm); 25% red (635 nm); and 25% green (525 nm). Alternatively, a controller may be provided that allows for changing the singular outputs of each color so that the user can control what color they would like to illuminate with. The LEDs will be dispersed evenly throughout the ring or the array as is well known. The lighting system 10 according to the embodiments of the invention houses all of the electronics in the base subassembly thereby simplifying the construction and manufacture of the device.

LEDs in an array were chosen because of their high efficiency in converting electrical current to light with very little creation of heat. In a preferred embodiment, the LED array consumes no more than 90 watts of power. Preferably the mounting structure has holes in the array that encapsulate each LED thereby capturing and sinking the individual LED's heat to the larger conducting surface of the full array which absorbs and radiates the heat away from the LEDs towards the outside surface of the housing 18.

By having the light source located under the reflective surfaces of the primary optics of the various embodiment described herein, as opposed to above the reflective surfaces as described in the prior art, there is the benefit that the heat generated by the light source can be isolated to reduce or prevent damage to the optics from heat generated by the LED array 20 and motor. Excessive heat, especially that generated by any filament bulb, can quickly degrade the optical surfaces and the motor 14 itself if not isolated carefully. The embodiments described herein contain and isolate the heat generated by the light source from the motor 14 and optical elements. Any heat generated is isolated and directed away from the optics and motor 14 using well known heat sinking techniques thus providing a system 10 that has a long life cycle. Thus, placing the LEDs in the base allows for mechanical protection as well as thermal isolation and heat conduction for the LEDs. It also allows for specific directional control of the overall illumination output from the LED array.

The hollow shaft of the motor is the conduit with which the overall illumination from the LEDs is passed through to the primary optics, e.g., mirror. The hollow shaft isolates the LEDs and heat generated by them from the primary optics.

More particularly, the light system 10 is mounted so that the base subassembly 12 is mounted to a structure and the motor 14 is mounted to a different structure. The LED ring and motor 14 are each contained in their own space. Each LED is surrounded by the LED ring by virtue of the mounting holes created for the LEDs. The LED ring is attached directly to the base subassembly 12 and heat generated by the LEDs will be captured and channeled directly to the housing of the base subassembly 12 and out to the structure on which the base subassembly 12 is mounted. The motor, likewise, is contained in its own space and is mounted by the top of the motor 14 to a structure. Heat generated by the motor 14 is captured by the top and sides of the structure and channeled down to the same base plate as well as radiating out from the surface of the structure.

In addition, the primary optics and rotation subassembly 16 are designed to have minimal load on the motor. With a load of approximately one ounce per inch, the motor 14 sees little torque load and runs with a minimal amount of heat created. The brushless motor 14 can operate continuously while consuming less than 10 total watts. Considering that heat rises, the motor 14 is mounted by its top to a mounting structure allowing any heat generated and radiated by the motor 14 to be absorbed and directed to the outside surface of the housing wherein it will be radiated to the outside air. These heat sinking techniques assure that the optics are not subjected to extreme heat which would result in rapid degradation of the optics and that any heat created by the motor is also directed away from the optics and motor. This allows for a long life product that should see a performance life span that exceeds 30,000 hours.

The operation of the system 10 will now be described. The motor 14 is energized so that its hollow shaft and thus the rotation subassembly 16 optics shaft rotate. The primary mirror is situated at the top end of the optics shaft and is spun by the motor. Through specific design of the face of the mirror, the primary mirror can distribute the outgoing light in a very defined and specific area. This eliminates light being distributed in any area except where it is needed. The spinning of the optics also offers attributes that cannot be offered by any other type of fixed illumination source. The light engine distributes its light in a uniform pattern without hot spots or dead zones. The light source is energized and the light generated thereby is directed by the beam control optics up through the hollow shaft 24 and into the optics shaft of the rotation subassembly 16 where it there impinges the reflective surface of the primary optics and is directed either out the window 30 of the optics shaft (FIG. 5) or through the side of the optics shaft (FIG. 7).

The device may be constructed to be permanently attached to a structure, such as a vehicle, for example, or it may be mobile so that it can be moved from place to place. The structure of the device provides compact packing with a mechanical envelope preferably no bigger than about 12 by 12 by 12 inches and a weight not to exceed 10 pounds. Because it preferably uses LED technology, it has good endurability. It has been found that the device can flood a 10,000 square foot area with “stadium lighting” while consuming no more power than a 100 W light bulb.

The device is powered by a battery, for example, a 12 volt battery, or it may be plugged into a source of energy, such as a vehicle's cigarette lighter or an AC/DC converter may be provided to plug the device into a wall socket. Alternately, the device may be powered by other sources of energy such as solar, as long as enough current is supplied. Preferably the power system 10 is a low power, low voltage system. By using a hollow shaft motor, the light source and the source for powering that light source, such as a battery, are located together. Because the light source does not need to be moved above the motor, all of the active electrical parts can be on a fixed platform within the base from which power can be distributed on a more reliable and permanent basis.

The light source may be selected so that is has a specific wavelength so that it may be used under certain conditions, such as a yellow light for fog, for example. In addition, the light source may be replaced by a microwave radiation source of an infrared laser, for example.

The dome 32 may be clear or it may have a color depending on the application to which the device is to be used. In addition, a dome 32 may not be needed in some applications. Also, the dome may be clear and have an opaque shade partially covering a portion thereof.

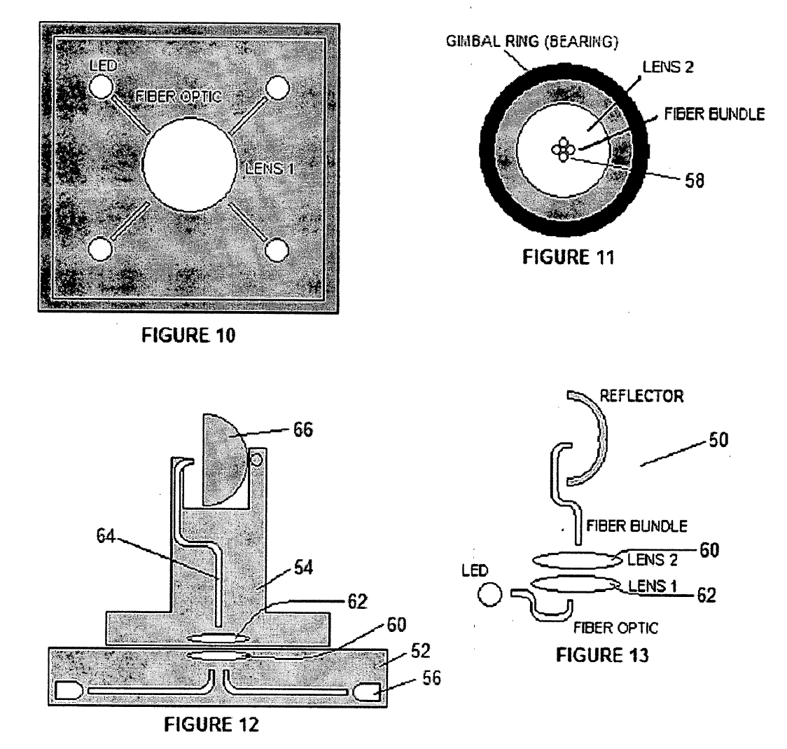

FIGS. 10-13 are schematic diagrams of a lighting system 50 according to another embodiment of the invention. In this embodiment there is a base subassembly 52 and a combined motor and rotation assembly 54. The base subassembly 52 includes a plurality of LEDs 56 each having a fiber optic cable 58 attached to its output. The outputs of the fiber optic cables are directed towards the center of the base subassembly 52 and focused on a lens 60. The motor/rotation assembly 54 sits on top of the base subassembly 52 and has a lens 62 aligned with the lens 60 in the base subassembly. A fiber optic cable 64 extends from the output of the lens to a reflector 66. The motor and rotation assembly rotate together. The light source generated by the LEDs is directed up to the reflector via the optic cables where it is reflected out of the rotation assembly.

The device may not only be used for flood illumination, but can also be used to illuminate a very focused area by stopping the revolution of the motor 14 and rotation subassembly 16. The device may also be provided with the ability to tip the light beam up and down and broaden or narrow the area of illumination. The vertical steering of the beam can be done by manipulating the beam control optics within the base subassembly 12 by providing additional optics such as a tilting mirror. Preferably, all of the control of the device from stopping/starting the motor 14 to tilting the beam would be controlled remotely from the device, e.g., wirelessly.

The applications for the device may range from flood lighting around farm machinery to construction equipment to building structures, such as barns and warehouses, parking lots, for example. In addition, the device could replace traditional automobile lighting systems. Military applications could include an infrared (IR) saturation around an airspace or ground-based vehicle or fixed object, blinding IR sensitive systems attempting to acquire said object as a target. Also, the device may be used for marine applications. Of course, the various components would need to be made waterproof.

The device is a value added illumination system that multiplies the usable lumens compared to a fixed LED source. As the LEDs increase in lumen output and decrease in power input, the device according to the embodiments of the invention has the latitude to incorporate ever improving LEDs into the device always ahead of total lumen output available from fixed arrays of these LEDs. In particular, the lumen output of the lighting devices according to the embodiments of the invention is at least a factor of 10 over that of a traditional, fixed light source.

What is claimed is:

1. An illumination device comprising:
a motor having a rotatable hollow shaft located to receive a beam of light;
a rotation assembly mounted on the motor, the rotation assembly includes a rotatable optics shaft coupled to the hollow shaft of the motor so that the optics shaft rotates with the hollow shaft of the motor; and
a reflector located in the optics shaft wherein the beam of light received by the hollow shaft of the motor travels through the rotatable optics shaft and impinges the reflector and is directed through a side wall of the optics shaft.

2. The illumination device of claim 1 further comprising a base coupled to the motor wherein the base houses a light source that generates the beam of light.

3. The illumination device of claim 2 wherein the light source is a ring of LEDs.

4. The illumination device of claim 2 wherein the light source is an array of LEDs.

5. The illumination device of claim 3 further comprising a collimation optical element located at the center of the ring of LEDs.

6. The illumination device of claim 5 wherein the collimation optical element is a cone reflector.

7. The illumination device of claim 1 wherein the reflector is tilted at an angle ranging from about 35 degree AOI to an angle of about 55 degree AOI.

8. The illumination device of claim 7 wherein the reflector is tilted at an angle of about 45 degrees AOI.

9. The illumination device claim 1 further comprising a dome covering the rotation assembly.

10. The illumination device of claim 9 wherein the dome is made of plastic.

11. The illumination device of claim 9 wherein the dome is made of glass.

12. The illumination device of claim 9 wherein the dome is made of a colored material.

13. The illumination device of claim 9 wherein the dome is made of a clear material.

14. The illumination device of claim 9 wherein the dome is made substantially of a clear material and includes an opaque shroud covering a portion thereof.

15. The illumination device of claim 1 further comprising a base wherein the base comprises:
a housing;
an LED array located along an inner perimeter of the housing; and
beam direction optics located at a center of the housing.

16. The illumination device of claim 1 wherein the optics shaft is hollow and has a window formed in a side wall of the optics shaft.

17. The illumination device of claim 1 wherein the optics shaft is a solid clear acrylic rod.

18. The illumination device of claim 1 wherein the motor rotates the hollow shaft at a speed ranging from about 3,000 rpm to about 10,000 rpm.

19. The illumination device of claim 15 wherein the LED array is formed by a ring having individual mounting positions for each LED.

20. The illumination device of claim 1 wherein the reflector is planar.

21. The illumination device of claim 1 wherein the reflector is curvilinear.

22. The illumination device of claim 21 wherein the reflector is convex.

23. The illumination device of claim 21 wherein the reflector is concave.

24. The illumination device of claim 1 wherein the rotatable optics shaft is hollow.

25. The illumination device of claim 1 wherein the rotatable optics shaft is made of a solid clear material.

26. The illumination device of claim 25 wherein the material is acrylic.

27. The illumination device of claim 1 further comprising a base wherein the base comprises:
a housing
an LED array located in a top of the housing wherein the LED array directs its illumination to a bottom of the housing
beam collector
a located on a floor of the housing.

28. The illumination device of claim 27 wherein the beam collector is a reflective parabolic dish.

29. The illumination device of claim 1 wherein the optics shaft is optically transmissive.

30. An illumination device comprising:
a motor having a rotatable hollow shaft located to receive a beam of light;
a rotation assembly mounted on the motor, the rotation assembly includes a rotatable optics shaft coupled to the hollow shaft of the motor so that the optics shaft rotates with the hollow shaft of the motor; and
primary optics located on the rotatable optics shaft wherein the beam of light received by the hollow shaft of the motor travels through the rotatable optics shaft and impinges the primary optics and is directed through a side wall of the rotation optics shaft.

31. The illumination device of claim 30 wherein the primary optics is a reflector.

32. The illumination device of claim 30 wherein the primary optics is formed by a piece of solid clear acrylic rod that has been cut on a diagonal into two portions wherein a reflective coating is formed on the diagonal cut surface and that portion is bonded to the remainder of the solid clear acrylic rod.

33. The illumination device of claim 30 wherein the optics shaft is optically transmissive.

34. A method of providing omnidirectional lighting, the method comprising the steps of:
Generating a concentrated beam of light using a plurality of LEDs; and
Sweeping the concentrated beam of light 360° at a rate ranging from about 3,000 rpm to about 10,000 rpm.
